(19) United States
(12) Patent Application Publication
(10) Pub. No.: US 2025/0319895 A1
(43) Pub. Date: Oct. 16, 2025

(54) Work Vehicle

(71) Applicant: Kubota Corporation, Osaka-shi (JP)

(72) Inventors: Shinya Tabata, Osaka (JP); Taisuke Hashimoto, Osaka (JP); Kohta Nakao, Osaka (JP)

(21) Appl. No.: 18/974,595

(22) Filed: Dec. 9, 2024

(30) Foreign Application Priority Data
Apr. 10, 2024 (JP) 2024-063260

(51) Int. Cl. B60W 50/14; B60W 50/02; G06F 3/16

(52) U.S. Cl. CPC B60W 50/14; B60W 50/0205; G06F 3/165; B60W 2050/021; B60W 2050/143; B60W 2050/146; B60W 2300/185

(57) ABSTRACT

A work vehicle includes a vehicle state detecting section configured to detect a vehicle state and output a state detecting signal, an abnormality detecting section configured to detect a vehicle abnormality based on the state detecting signal, an abnormal state determination section configured to determine an abnormal state of the vehicle abnormality thus detected, an output period pattern determination section configured to determine one output period pattern from a plurality of output period patterns of simple audible sound based on the abnormal state, and an acoustic device configured to repeatedly output the simple audible sound based on the one output period pattern determined by the output period pattern determination section as abnormality notification sound.

### CROSS-REFERENCE TO RELATED APPLICATION

This application claims priority to Japanese Patent Application No. 2024-063260 filed Apr. 10, 2024, the disclosure of which is hereby incorporated by reference in its entirety.

### BACKGROUND OF THE INVENTION

### Field of the Invention

The present invention relates to a work vehicle configured to detect a vehicle abnormality and perform abnormality notification.

### Description of Related Art

A work vehicle, as disclosed in US Patent Application Publication No. 2018/0038460, includes a notification section configured to perform warning to give a warning about abrasion of a drive belt in a case where an engine rotation speed detected by a rotation detecting section exceeds a predetermined allowable range though a vehicle speed detected by a vehicle speed detecting section is a predetermined vehicle speed. Herein, a buzzer device as a sound production device configured to produce sound is described as an example of the notification section.

US Patent Application Publication No. 2018/0338414 discloses a work vehicle (a mower) configured to, when a vehicle trouble is detected, cause a driver to recognize the vehicle trouble by providing pulsation to rotational drive of a mower blade of a mower unit. At this time, the work vehicle is controlled such that the pulsation is larger as the vehicle speed becomes faster.

In the work vehicle in US 2018/0038460, the driver can grasp an abnormality in the drive belt by a buzzer, but the driver cannot grasp other vehicle abnormalities by the buzzer. In US 2018/0338414, it is possible to grasp a vehicle trouble by rotations of the mower unit which rotations are accompanied by the pulsation. Besides, the pulsation is made stronger during high-speed traveling so as to solve a problem that the driver hardly feels the pulsation due to vibration caused by the high-speed traveling. However, US 2018/0338414 does not consider causing the driver to grasp various vehicle troubles only by pulsation changes, and it is difficult for the driver to grasp the type of a vehicle trouble based on the intensity of pulsation.

### SUMMARY OF THE INVENTION

From such circumstances, an object of the present invention is to achieve, with a simple configuration, a technology that allows a driver to grasp various vehicle abnormalities in such a manner as to distinguish the vehicle abnormalities from each other.

A work vehicle according to the present invention includes: a vehicle state detecting section configured to detect a vehicle state and output a state detecting signal; an abnormality detecting section configured to detect a vehicle abnormality based on the state detecting signal; an abnormal state determination section configured to determine an abnormal state of the vehicle abnormality thus detected; an output period pattern determination section configured to determine one output period pattern from a plurality of output period patterns of simple audible sound, based on the abnormal state; and an acoustic device configured to repeatedly output the simple audible sound based on the one output period pattern determined by the output period pattern determination section as abnormality notification sound.

In this configuration, the acoustic device outputs the simple audible sound in an output period pattern determined based on an abnormal state. Although the simple audible sound is just output, a person hearing the simple audible sound can grasp a particular abnormal state by recognizing the output period pattern. In addition, a buzzer can be used as the acoustic device configured to output the simple audible sound, and this configuration is also advantageous in terms of cost. Here, the simple audible sound means a beep sound such as “buzz” or “beep.”

The output period pattern is a combination (rhythm) of an output time and a stopping time of the simple audible sound. Accordingly, given patterns selected appropriately can be assigned to various abnormal states. For example, it is preferable to select an output period pattern having a characteristic rhythm that psychologically gives feeling of strain for an abnormal state with a high degree of urgency of notification. In view of this, in the present invention, the plurality of output period patterns each may define an output time and a stopping time of the simple audible sound in a repetition period.

The vehicle state of the work vehicle includes a driving state such as an engine state or a shift state in the vehicle, an operation state of an operation tool to be operated by a driver, a driver state indicative of whether or not the driver is in a regular position or posture, and so on. In view of this, in the present invention, the vehicle state may include a vehicle driving state, a vehicle operation state, and a driver state, and in a case where the abnormal state is highly likely to cause a large damage, the output period pattern derived based on the abnormal state may have a sound volume set to a notification sound volume recognizable even outside the work vehicle.

The vehicle abnormality includes various abnormalities, and even the same vehicle abnormality has various abnormality levels (abnormality degrees). For example, a rotation speed abnormality or exceeding in speed limit has a variety of abnormality levels depending on how far a rotation speed or a vehicle speed is away from its allowable range. In view of this, in the present invention, the abnormal state may include a type of the vehicle abnormality and an abnormality level of the vehicle abnormality. Hereby, it is possible to perform abnormality notification corresponding to the type of the abnormal state or the abnormality level of the abnormal state.

A vehicle is often brought into an abnormal state due to complex factors. In such a case, the abnormal state includes a plurality of types of abnormal states, and therefore, it is important that a most important abnormal state is notified. In view of this, in the present invention, the abnormal state may include a notification priority level, and an abnormal state with a highest notification priority level may be notified preferentially.

In a case where an abnormality occurs in the vehicle, it is important to cause a driver to notice the occurrence of the abnormality by the simple audible sound first, but it is also important to give more specific abnormality information to the driver at the same time as or after notification of the occurrence of the abnormality. It is preferable to notify the driver of such detailed abnormality information by a code or a message indicative of the abnormal state. In view of this, in the present invention, the work vehicle may further include a display device configured to display a code or a message indicative of the abnormal state at the same time that the simple audible sound is output.

### BRIEF DESCRIPTION OF THE DRAWINGS

FIG. 1 is a side view of a multipurpose vehicle;

FIG. 2 is a plan view of the multipurpose vehicle;

FIG. 3 is a functional block diagram illustrating functional sections constituting a control unit; and

FIG. 4 is a schematic block diagram to describe a pattern deriving section.

### DESCRIPTION OF THE INVENTION

The following describes a multipurpose vehicle as an example of a work vehicle of the present invention. Note that, in the following description, in terms of the multipurpose vehicle, a direction of an arrow F illustrated in the drawings is referred to as a “vehicle-body front side,” a direction of an arrow B is referred to as a “vehicle-body rear side,” a direction of an arrow U is referred to as a “vehicle-body upper side,” a direction of an arrow D is referred to as a “vehicle-body lower side,” a direction of an arrow L is referred to as a “vehicle-body left side,” and a direction of an arrow R is referred to as a “vehicle-body right side.”

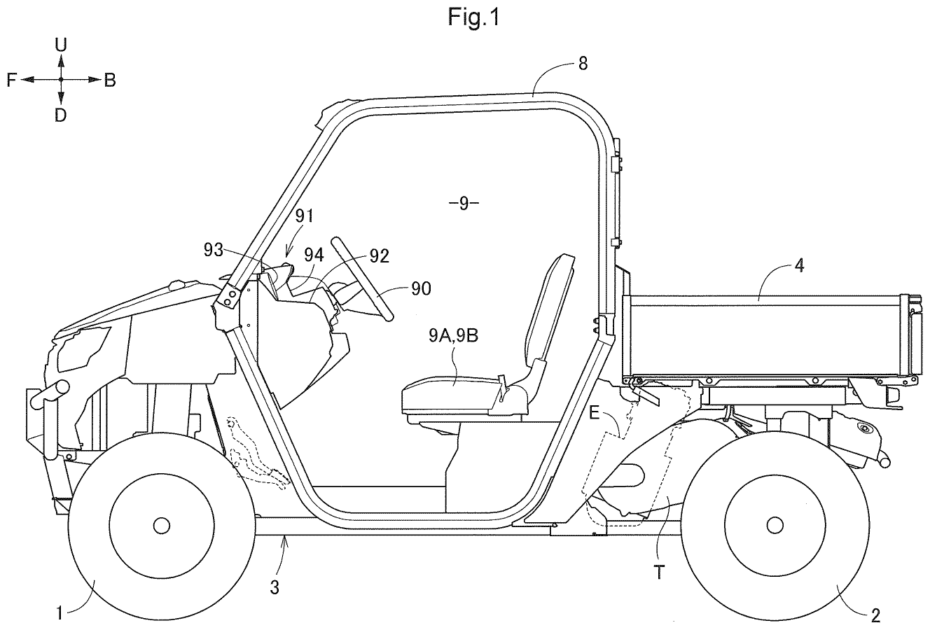

As illustrated in FIG. 1, the multipurpose vehicle includes a body frame 3 supported by a pair of right and left front wheels 1 and a pair of right and left and rear wheels 2 in such a manner as to be grounded. The front wheels 1 are drivable and steerable, and the rear wheels 2 are drivable. A driving section 9 is at a front portion of the body frame 3, and a cargo box 4 is at a rear portion of the body frame 3. An engine E and a transmission T are under the cargo box 4. The driving section 9 is surrounded by a ROPS 8.

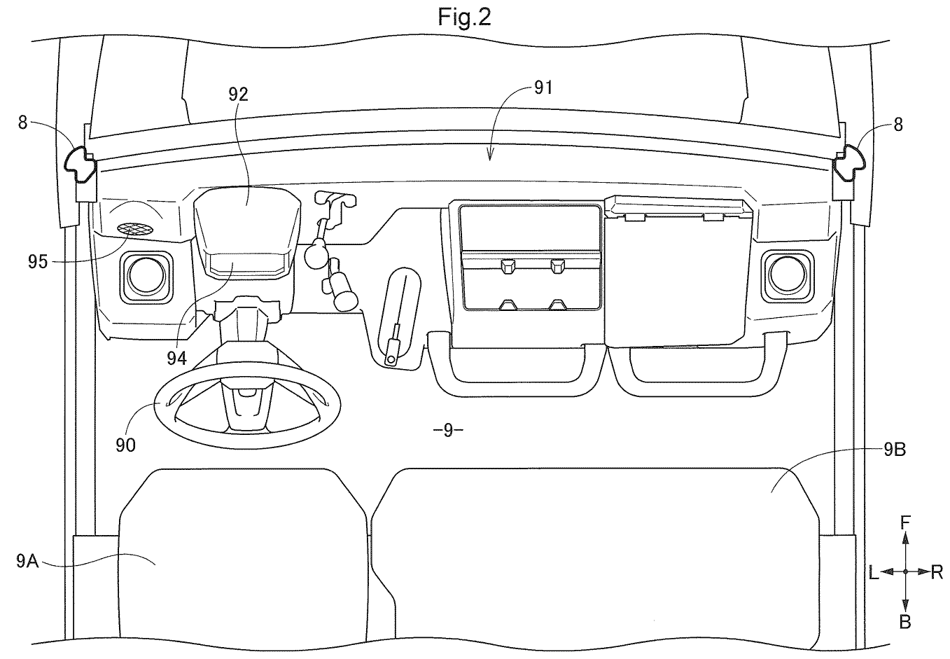

As illustrated in FIGS. 1, 2, the driving section 9 is provided with a driver seat 9A and a passenger seat 9B. A steering wheel 90 is forward of the driver seat 9A, and a dashboard 91 including an instrument panel 92 is forward of the steering wheel 90. As illustrated in FIG. 2, a display 94 as a display device and various operation buttons are provided for the instrument panel 92. The dashboard 91 is also provided with a buzzer 93 as an acoustic device. The buzzer 93 may be provided for the instrument panel 92. Although not illustrated herein, the driving section 9 is provided with an accelerator pedal configured to adjust a traveling speed, a brake pedal configured to perform braking, and a manual operating tool such as a shift lever configured to perform shifting.

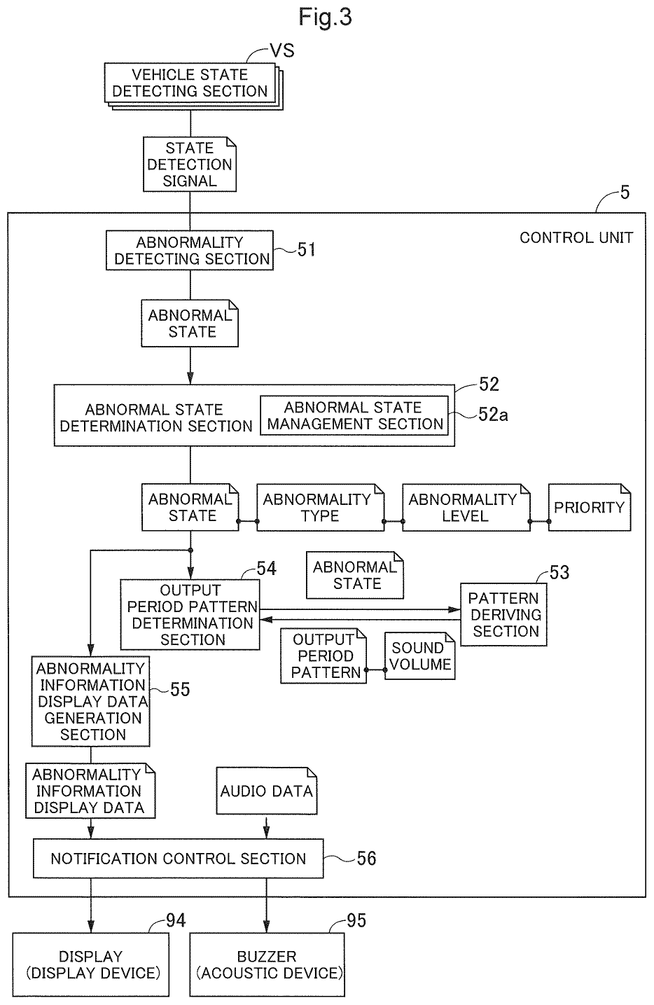

FIG. 3 is a functional block diagram illustrating functional sections related to an abnormality notification function to notify a vehicle abnormality, in the control unit 5.

The vehicle includes various vehicle state detecting sections VS for detecting a vehicle driving state, a vehicle operation state, a driver state, and the like. Accordingly, the vehicle state detecting sections VS include an engine sensor for detecting an engine state, a shift sensor for detecting a driving state such as a shift state, an operation detection sensor for detecting an operation state of an operation tool operated by the driver, a driver sensor for detecting whether the driver is in a regular position or not, and so on. The vehicle state detecting sections VS each output a state detecting signal as a detection result.

The control unit 5 includes, as functional sections particularly related to the present invention, an abnormality detecting section 51, an abnormal state determination section 52, a pattern deriving section 53, an output period pattern determination section 54, an abnormality information display data generation section 55, and a notification controlling section 56. These functional sections are achieved by software, hardware, or both of them.

The abnormality detecting section 51 detects a vehicle abnormality based on state detecting signals transmitted from the vehicle state detecting sections VS. The abnormality detecting section 51 transmits, to the abnormal state determination section 52, a state detecting signal considered to be a vehicle abnormality from among the state detecting signals, as a vehicle abnormality (abnormal state detection signal data). Note that the abnormality detecting section 51 can detect various vehicle abnormalities from various state detecting signals substantially at the same time. For example, a vehicle speed abnormality and a shifting operation abnormality may be detected at the same time.

The abnormal state determination section 52 analyzes the abnormal state detection signal data acquired as the vehicle abnormality from the abnormality detecting section 51 more in detail by use of a threshold determination, a rule determination, or the like, and determines an abnormal state including an abnormality type and an abnormality level of the vehicle abnormality. In view of this, the abnormal state determination section 52 includes an abnormal state management section 52a having algorithm to determine an abnormal state including an abnormality type and an abnormality level based on contents of the abnormal state detection signal data.

For example, as illustrated in FIG. 3, an abnormality type, an abnormality level, and a priority are given as attribute values to the abnormal state output from the abnormal state determination section 52. The priority indicates a notification priority level, and an abnormal state with the highest notification priority level is notified preferentially.

The output period pattern determination section 54 determines one output period pattern from a plurality of output period patterns of simple audible sound, based on the abnormal state received from the abnormal state determination section 52. The pattern deriving section 53 is used to determine the output period pattern. Note that, in a case where abnormal states are given substantially at the same time (or consecutively), an abnormal state with a higher notification priority level is accepted as a process target.

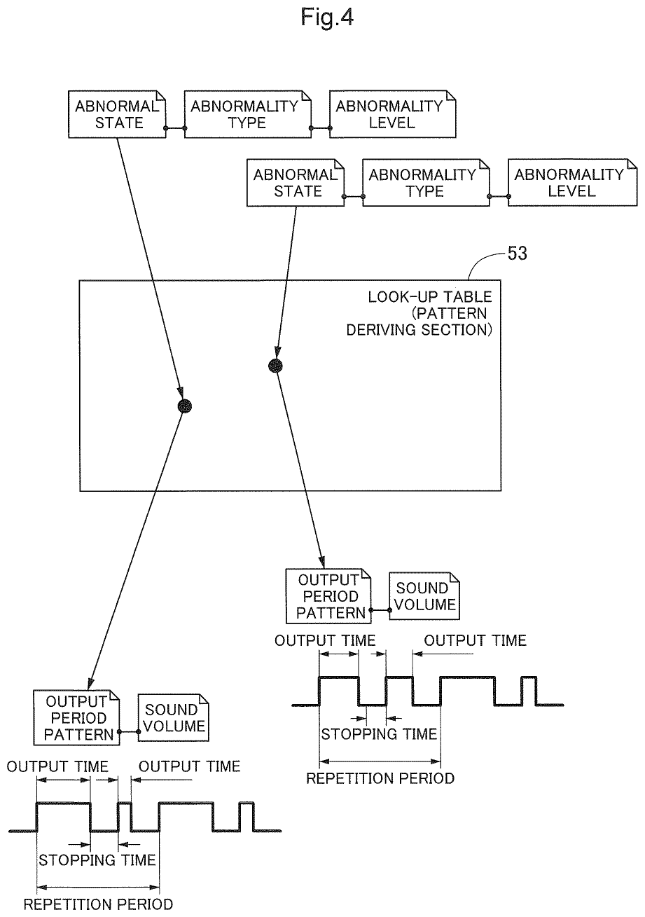

As schematically illustrated in FIG. 4, the pattern deriving section 53 is configured as a look-up table. When the pattern deriving section 53 receives an abnormal state including an abnormality type, an abnormality level, and a priority as attribute values, the pattern deriving section 53 derives an output period pattern suitable for the abnormal state and returns it to the output period pattern determination section 54. The output period pattern determination section 54 determines the received output period pattern as an output period pattern to notify the abnormal state this time and gives the output period pattern to the notification controlling section 56.

FIG. 4 illustrates two output period patterns. The output period patterns each define an output time and a stopping time of the simple audible sound in a repetition period. The repetition period may include one or more output times and one or more stopping times, and in a case where the repetition period includes a plurality of output times and a plurality of stopping times, the plurality of output times may be different from each other, and the plurality of stopping times may be different from each other.

In this embodiment, the output period pattern to be given to the notification controlling section 56 is accompanied by data defining a sound volume. Particularly, in a case where an abnormal state is highly likely to cause a large damage, a sound volume accompanying an output period pattern derived based on the abnormal state is a notification sound volume recognizable even outside the vehicle. In other abnormal states, the same sound volume is applied.

The notification controlling section 56 generates a buzzer driving signal based on the output period pattern thus received and outputs the buzzer driving signal to the buzzer 95. Hereby, the buzzer 95 repeatedly outputs the simple audible sound based on the output period pattern as abnormality notification sound. Note that the abnormality notification sound output by the buzzer 95 can be stopped by an operation performed by a given operation tool.

The abnormality information display data generation section 55 generates display data to be displayed on the display 94 at the same time as abnormality notification by the simple audible sound output by the buzzer 95, and the display data includes a code, a message, or the like indicative of the notified abnormal state. Hereby, at the same time as the abnormal notification by the buzzer 95, the code, message, or the like indicative of the abnormal state is displayed on the display 94.

### Alternative Embodiments

(1) In the above embodiment, the tone of the buzzer 95 is not limited, but the output period pattern can include tones, provided that the buzzer 95 can output at least a high tone and a low tone as the tones.

(2) In the above embodiment, the buzzer 95 is used as an acoustic device, but an acoustic device that can output simple audible sound, except the buzzer 95, e.g., a bell, a speaker, a bone conduction headphone, or the like, may be used.

(3) In the above embodiment, the present invention is applied to a multipurpose vehicle but is also applicable to all work vehicles such as a mower, a snowplow truck, a tractor, and a harvester, other than the multipurpose vehicle.

Note that the configurations described in the above embodiment (including the alternative embodiments; the same applies hereinafter) can be applied in combination with configurations of other embodiments as long as no inconsistency occurs. The embodiments described in the present specification are illustrative and should not be construed as limiting the present invention. Modifications to the present invention are permissible, as long as they do not deviate from the scope that can achieve the objects of the present invention.

### INDUSTRIAL APPLICABILITY

The present invention is applied to a work vehicle configured to detect a vehicle abnormality and perform abnormality notification.

### DESCRIPTION OF THE REFERENCE NUMERALS

5: control unit
51: abnormality detecting section
52: abnormal state determination section
52a: abnormal state management section
53: pattern deriving section
54: output period pattern determination section
55: abnormality information display data generation section
56: notification controlling section
92: instrument panel
94: display
95: buzzer (acoustic device)
VS: vehicle state detecting section

What is claimed is:

1. A work vehicle, comprising:
a vehicle state detecting section configured to detect a vehicle state and output a state detecting signal;
an abnormality detecting section configured to detect a vehicle abnormality based on the state detecting signal;
an abnormal state determination section configured to determine an abnormal state of the vehicle abnormality thus detected;
an output period pattern determination section configured to determine one output period pattern from a plurality of output period patterns of simple audible sound, based on the abnormal state; and
an acoustic device configured to repeatedly output the simple audible sound based on the one output period pattern determined by the output period pattern determination section as abnormality notification sound.

2. The work vehicle according to claim 1, wherein:
the plurality of output period patterns each define an output time and a stopping time of the simple audible sound in a repetition period.

3. The work vehicle according to claim 2, wherein:
the vehicle state comprises a vehicle driving state, a vehicle operation state, and a driver state, and
in a case where the abnormal state is highly likely to cause a large damage, the output period pattern derived based on the abnormal state has a sound volume set to a notification sound volume recognizable even outside the work vehicle.

4. The work vehicle according to claim 1, wherein:
the abnormal state comprises a type of the vehicle abnormality and an abnormality level of the vehicle abnormality.

5. The work vehicle according to claim 1, wherein:
the abnormal state comprises a notification priority level, and
an abnormal state with a highest notification priority level is notified preferentially.

6. The work vehicle according to claim 1, further comprising:
a display device configured to display a code or a message indicative of the abnormal state at the same time that the simple audible sound is output.

7. The work vehicle according to claim 1, wherein:
the acoustic device is a buzzer.
